(19) United States
(12) Patent Application Publication
(10) Pub. No.: US 2024/0117500 A1
(43) Pub. Date: Apr. 11, 2024

(54) ANTICORROTION SYSTEM

(71) Applicant: Nippon Telegraph and Telephone Corporation, Tokyo (JP)

(72) Inventors: Mamoru Mizunuma, Tokyo (JP); Shingo Mineta, Tokyo (JP); Shota Oki, Tokyo (JP); Soichi Oka, Tokyo (JP)

(21) Appl. No.: 18/546,228

(22) PCT Filed: Feb. 25, 2021
(86) PCT No.: PCT/JP2021/007029

§ 371 Date: Aug. 11, 2023

(51) Int. Cl. C23F 13/20; C23F 13/12; H02S 20/10; H02S 40/30

(52) U.S. Cl. CPC C23F 13/20; C23F 13/12; H02S 20/10; H02S 40/30

(57) ABSTRACT

An anchor is buried in the ground near a place where a utility pole is installed. A guy wire is connected to the utility pole. A guy wire rod couples the anchor and the guy wire. An electrode is buried in the ground near a place where the anchor is buried. A power supply supplies an anti-corrosion current with an underground portion of the guy wire rod and the anchor as a cathode and the electrode as an anode. The power supply includes a photovoltaic cell.

### CROSS-REFERENCE TO RELATED APPLICATIONS

This application is a national phase entry of PCT Application No. PCT/JP2021/007029, filed on Feb. 25, 2021, which application is hereby incorporated herein by reference.

### TECHNICAL FIELD

The present invention relates to an anti-corrosion system that prevents corrosion of an anchor buried in the ground for supporting a utility pole.

### BACKGROUND

A utility pole is a typical overhead structure and is present on the ground to support, for example, communication and power transmission lines. It is also a critical infrastructure for providing power transmission and communication services (see Patent Literature 1). The largest load that the utility pole has to bear is the tension of installed electric wires. For this reason, for example, a utility pole that is a terminal end of a portion where the entire underline wires are retained is provided with a guy wire stretched to the surrounding ground in order to withstand a horizontal load and an unbalanced load of the electric wires. For example, one end of the guy wire is connected to an upper portion of the utility pole, and the other end of the guy wire is connected to an anchor buried in the surrounding ground via a guy wire rod. The anchor fixes the guy wire to the ground via the guy wire rod.

The guy wire rod and the anchor are exposed to the natural environment, in particular, temperature changes, rainfall, snowfall, sea salt particles and the like. Accordingly, corrosion is likely to occur. Depending on soil properties, corrosion may further progress; and in some cases, the guy wire rod may not generate sufficient force to support the utility pole. As a solution for such an issue, a technology has been proposed in which a DC power supply device is provided to supply an anti-corrosion current to a guy wire rod and an anchor to prevent corrosion (see Patent Literature 2).

### CITATION LIST

### Patent Literature

Patent Literature 1: JP S62-182370 A

Patent Literature 2: JP 6325761 B

### SUMMARY

### Technical Problem

However, guy wire rods and anchors have been buried (placed) in the ground all over Japan for a long time, e.g., 30 years or more, and thus it is not easy to procure power supplies for such a long period of time.

Embodiments of the present invention have been made to solve the problems above, and an object of embodiments of the present invention is to supply an anti-corrosion current to a guy wire rod and an anchor buried in the ground over a long period of time.

### Solution to Problem

An anti-corrosion system according to embodiments of the present invention includes: a utility pole installed on the ground; an anchor buried in the ground near a place where the utility pole is installed; a guy wire connected to the utility pole; a guy wire rod that couples the anchor and the guy wire; an electrode buried in the ground near a place where the anchor is buried; and a power supply that supplies anti-corrosion current with an underground portion of the guy wire rod and the anchor as a cathode and the electrode as an anode, wherein the power supply consists of a photovoltaic cell.

Another anti-corrosion system according to embodiments of the present invention includes: a utility pole installed on the ground; an anchor buried in the ground near a place where the utility pole is installed; a guy wire connected to the utility pole; a guy wire rod that couples the anchor and the guy wire; an electrode buried in the ground near a place where the anchor is buried; and a power supply that supplies anti-corrosion current with an underground portion of the guy wire rod and the anchor as a cathode and the electrode as an anode, wherein the power supply includes a commercial power supply and a DC-AC converter.

### Advantageous Effects of Embodiments of the Invention

As described above, according to embodiments of the present invention, the anti-corrosion current is generated using the photovoltaic cell or the commercial power supply, thus it is possible to supply the anti-corrosion current to the guy wire rod and the anchor buried in the ground over a long time of period.

### BRIEF DESCRIPTION OF THE DRAWINGS

FIG. 1 is a configuration diagram illustrating a configuration of an anti-corrosion system according to a first embodiment of the present invention.

FIG. 2 is a configuration diagram illustrating a configuration of an anti-corrosion system according to a second embodiment of the present invention.

### DETAILED DESCRIPTION OF ILLUSTRATIVE EMBODIMENTS

An anti-corrosion system according to embodiments of the present invention will be described hereinbelow.

### First Embodiment

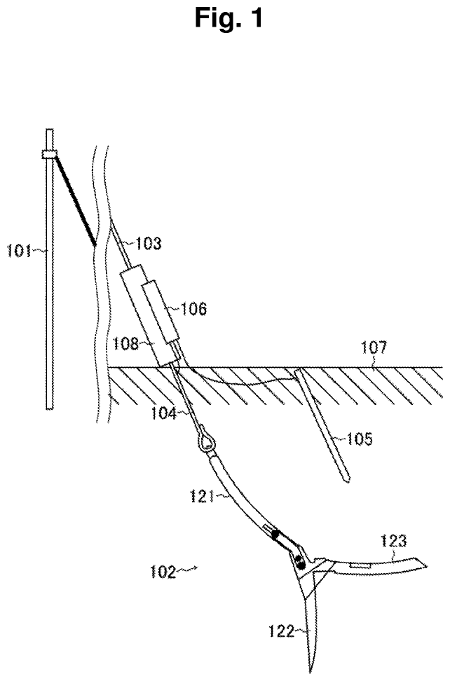

An anti-corrosion system according to a first embodiment of the present invention will be described with reference to FIG. 1. The system includes a utility pole 101, an anchor 102, a guy wire 103, a guy wire rod 104, an electrode 105, and a power supply 106.

The utility pole 101 is installed on the ground. The anchor 102 is buried in the ground (underground 107) near a place where the utility pole 101 is installed. The guy wire 103 is connected to the utility pole 101. The guy wire rod 104 couples the anchor 102 and the guy wire 103. The anchor 102, the guy wire 103, and the guy wire rod 104 are made of a steel material. The guy wire 103 may be made of, for example, a steel strand. Further, the guy wire rod 104 may be made of, for example, a steel rod member.

The electrode 105 is buried in the ground (underground 107) near a place where the anchor 102 is buried. The electrode 105 can be made of, for example, a mixed metal oxide (MMO) in which metal titanium is coated with iridium oxide. The electrode 105 can also be made of platinum-plated titanium (platinum-titanium electrode). The electrode 105 can also be made of cast iron (high silicon cast iron) containing silicon at a high concentration. These poorly soluble electrodes, such as the MMO electrode, the platinum-titanium electrode, and the high silicon cast iron electrode, can be kept for a longer period of time.

The power supply 106 supplies an anti-corrosion current with an underground portion of the guy wire rod 104 and the anchor 102 as a cathode, and the electrode 105 as an anode. In the first embodiment, the power supply 106 consists of a photovoltaic cell. The photovoltaic cell can be a flexible photovoltaic panel. In the first embodiment, the system further includes a guy wrap 108 provided on a ground portion of the guy wire rod 104. In the first embodiment, the power supply 106 is attached to the guy wrap 108. The flexible photovoltaic panel includes dye-sensitized or organic photovoltaic cells, and has an energy conversion (sunlight to power) efficiency of 10% range, while it is suitable for being attached to a columnar surface of the guy wrap 108 to serve as a DC power supply device.

The anchor 102 supporting the guy wire 103 on the ground includes a guide plate 121 to which the guy wire rod 104 is connected on a distal end side, a resistance plate 122 that is curved and extends from a proximal end side of the guide plate 121, and a stabilization plate 123 that extends from a proximal end side of the resistance plate 122. A distal end of the resistance plate 122 and a distal end of the guide plate 121 face a side of the utility pole 101, and a distal end of the stabilization plate 123 faces a direction intersecting s direction of the utility pole 101 in a plan view. These are each an independent component. Therefore, the guide plate 121, the resistance plate 122, and the stabilization plate 123 may be connected (fastened) to each other via a conductive wire (e.g., a copper wire) to ensure conduction between these components and the power supply 106.

The power supply 106 including the photovoltaic cell generates an electromotive force during daytime with fair weather to supply the anti-corrosion current in the ground 107, and consequently the anti-corrosion effect can be obtained for the guy wire rod 104 and the anchor 102 buried in the ground (underground 107). Since the power supply 106 including the photovoltaic cell can generate the electromotive force for a long period of time, e.g., 30 years, the anchor 102 and the guy wire rod 104 have extended corrosion lives. It is possible to support the utility pole 101 in a safe manner for a longer period of time as compared to the prior art.

The steel material used for the anchor 102 and the guy wire rod 104 is an iron product (energetically unstable) obtained by refining iron ores (iron oxides) in a factory and removing oxygen. Corrosion is the phenomenon in which this energetically unstable product is converted (oxidized) to a more stable form (iron oxide). Therefore, oxygen (02) is essential for corrosion of the steel material. The steel material used for the anchor 102 and the guy wire rod 104 is bonded to oxygen in the ground (underground 107; in the soil) to return to the original iron oxide (corroded).

Electrons are supplied to the anchor 102 and the guy wire rod 104, subject to anti-corrosion using the anti-corrosion current, by connecting the electrode 105 as an anode and flowing the anti-corrosion current (external power supply). Corrosion is suppressed by bonding the supplied electrons and iron ions on surfaces of the anchor 102 and the guy wire rod 104. In the first embodiment, it is essential to suppress consumption of the electrode 105 serving as the anode. Therefore, the electrode 105 should be made of an insoluble substance. As described above, it is preferable to use the poorly soluble electrode such as an MMO electrode, a platinum-titanium electrode, or a high silicon cast iron electrode.

### Second Embodiment

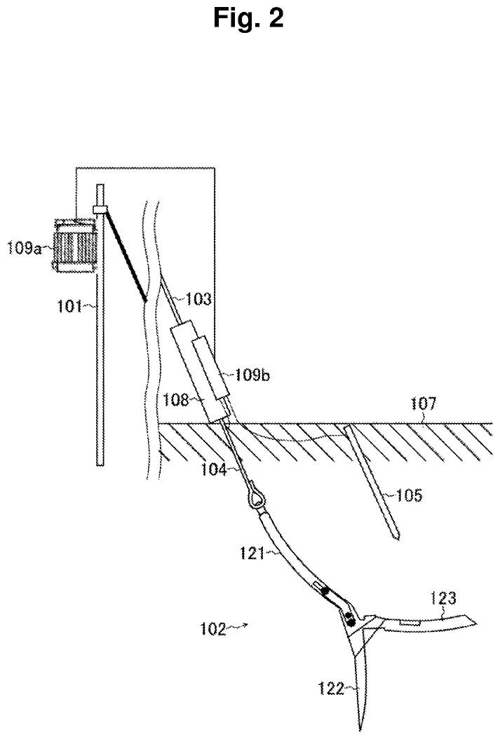

An anti-corrosion system according to a second embodiment of the present invention will be described with reference to FIG. 2. The system includes a utility pole 101, an anchor 102, a guy wire 103, a guy wire rod 104, an electrode 105, a commercial power supply 109a, and a DC-AC converter 109b.

The utility pole 101 is installed on the ground. The anchor 102 is buried in the ground (underground 107) near a place where the utility pole 101 is installed. The guy wire 103 is connected to the utility pole 101. The guy wire rod 104 couples the anchor 102 and the guy wire 103. The anchor 102, the guy wire 103, and the guy wire rod 104 are made of a steel material. The guy wire 103 may be made of, for example, a steel strand. Further, the guy wire rod 104 may be made of, for example, a steel rod member.

The electrode 105 is buried in the ground (underground 107) near a place where the anchor 102 is buried. The electrode 105 can be made of, for example, a mixed metal oxide (MMO) in which metal titanium is coated with iridium oxide. The electrode 105 can also be made of platinum-plated titanium (platinum-titanium electrode). The electrode 105 can also be made of cast iron (high silicon cast iron) containing silicon at a high concentration. These poorly soluble electrodes, such as the MMO electrode, the platinum-titanium electrode, and the high silicon cast iron electrode, can be kept for a longer period of time.

The commercial power supply 109a and the DC-AC converter 109b, as a power supply, supply an anti-corrosion current with an underground (107) portion of the guy wire rod 104 and the anchor 102 as a cathode, and the electrode 105 as an anode. The utility pole 101 is, for example, a so-called joint pole in which a communication line is carried at a lower portion and a power line is carried at an upper portion. In such a utility pole 101, a 100-V alternating-current wire (commercial power supply) hangs at the upper portion of the utility pole 101, which can be used in embodiments of the present invention. In a case where a higher voltage is applied to the utility pole 101, the commercial power supply 109a may consist of a pole-mounted transformer provided on the utility pole 101. In the second embodiment, the system further includes a guy wrap 108 provided on a ground portion of the guy wire rod 104. In the second embodiment, the DC-AC converter 109b is attached to the guy wrap 108.

The anchor 102 supporting the guy wire 103 on the ground includes a guide plate 121 to which the guy wire rod 104 is connected on a distal end side, a resistance plate 122 that is curved and extends from a proximal end side of the guide plate 121, and a stabilization plate 123 that extends from a proximal end side of the resistance plate 122. A distal end of the resistance plate 122 and a distal end of the guide plate 121 face a side of the utility pole 101, and a distal end of the stabilization plate 123 faces a direction intersecting s direction of the utility pole 101 in a plan view. These are each an independent component. Therefore, the guide plate 121, the resistance plate 122, and the stabilization plate 123 may be connected (fastened) to each other via a conductive wire (e.g., a copper wire) to ensure conduction between these components and the power supply.

The commercial power supply 109a serving as the power supply is activated while the utility pole 101 is in use and can supply power over a long period of time, e.g., 30 years or more. According to the second embedment, it is possible to supply anti-corrosion current for a long period of time, thereby the anchor 102 and the guy wire rod 104 have extended corrosion lives. Therefore, it is possible to support the utility pole 101 in a safe manner for a longer period of time as compared to the prior art.

The steel material used for the anchor 102 and the guy wire rod 104 is an iron product (energetically unstable) obtained by refining iron ores (iron oxides) in a factory and removing oxygen. Corrosion is the phenomenon in which this energetically unstable product is converted (oxidized) to a more stable form (iron oxide). Therefore, oxygen (02) is essential for corrosion of the steel material. The steel material used for the anchor 102 and the guy wire rod 104 is bonded to oxygen in the ground (underground 107; in the soil) to return to the original iron oxide (corroded).

Electrons are supplied to the anchor 102 and the guy wire rod 104, subject to anti-corrosion using the anti-corrosion current, by connecting the electrode 105 as an anode and flowing the anti-corrosion current (external power supply). Corrosion is suppressed by bonding the supplied electrons and iron ions on surfaces of the anchor 102 and the guy wire rod 104. In the second embodiment, it is essential to suppress consumption of the electrode 105 serving as the anode. Therefore, the electrode 105 should be made of an insoluble substance. As described above, it is preferable to use the poorly soluble electrode such as an MMO electrode, a platinum-titanium electrode, or a high silicon cast iron electrode.

As described above, according to embodiments of the present invention, the anti-corrosion current is generated using the photovoltaic cell or the commercial power supply, thus it is possible to supply the anti-corrosion current to the guy wire rod and the anchor buried in the ground over a long time of period.

The embodiments of the present invention are not limited to the embodiments above, and it will be appreciated to those skilled in the art that modifications and combinations can be made without departing from the scope of the present invention.

### REFERENCE SIGNS LIST

101 Utility pole
102 Anchor
103 Guy wire
104 Guy wire rod
105 Electrode
106 Power supply
107 Underground
108 Guy wrap
109a Commercial power supply
109b DC-AC converter
121 Guide plate
122 Resistance plate
123 Stabilization plate

1.-7. (canceled)

8. An anti-corrosion system comprising:
a utility pole installed on a ground;
an anchor buried in the ground next to the utility pole;
a guy wire connected to the utility pole;
a guy wire rod coupling the anchor and the guy wire;
an electrode buried in the ground next to the anchor; and
a power supply configured to supply an anti-corrosion current with an underground portion of the guy wire rod and the anchor as a cathode and the electrode as an anode, wherein the power supply comprises a photovoltaic cell.

9. The anti-corrosion system according to claim 8, wherein the photovoltaic cell comprises a flexible photovoltaic panel.

10. The anti-corrosion system according to claim 8, further comprising a guy wrap on an above ground portion of the guy wire rod, wherein a portion of the power supply is attached to the guy wrap.

11. The anti-corrosion system according to claim 10, wherein the guy wire rod and the anchor each comprise a steel material.

12. The anti-corrosion system according to claim 11, wherein the electrode comprises a poorly soluble electrode.

13. The anti-corrosions system according to claim 12, wherein the poorly soluble electrode comprises a composite metal oxide electrode, a platinum-titanium electrode, or a high silicon cast iron electrode.

14. The anti-corrosion system according to claim 8, wherein the guy wire rod and the anchor each comprise a steel material.

15. The anti-corrosion system according to claim 8, wherein the electrode comprises a poorly soluble electrode.

16. The anti-corrosions system according to claim 15, wherein the poorly soluble electrode comprises a composite metal oxide electrode, a platinum-titanium electrode, or a high silicon cast iron electrode.

17. An anti-corrosion system comprising:
a utility pole installed on a ground;
an anchor buried in the ground next to the utility pole;
a guy wire connected to the utility pole;
a guy wire rod coupling the anchor and the guy wire;
an electrode buried in the ground next to the anchor; and
a power supply configured to supply an anti-corrosion current with an underground portion of the guy wire rod and the anchor as a cathode and the electrode as an anode, wherein the power supply comprises a commercial power supply and a DC-AC converter.

18. The anti-corrosion system according to claim 17, wherein the commercial power supply comprises a pole-mounted transformer on the utility pole.

19. The anti-corrosion system according to claim 17, further comprising a guy wrap on an above ground portion of the guy wire rod, wherein a portion of the power supply is attached to the guy wrap.

20. The anti-corrosion system according to claim 19, wherein the guy wire rod and the anchor each comprise a steel material.

21. The anti-corrosion system according to claim 20, wherein the electrode comprises a poorly soluble electrode.

22. The anti-corrosion system according to claim 21, wherein the poorly soluble electrode comprises a composite metal oxide electrode, a platinum-titanium electrode, or a high silicon cast iron electrode.

23. The anti-corrosion system according to claim 17, wherein the guy wire rod and the anchor each comprise a steel material.

24. The anti-corrosion system according to claim 17, wherein the electrode comprises a poorly soluble electrode.

25. The anti-corrosion system according to claim 24, wherein the poorly soluble electrode comprises a composite metal oxide electrode, a platinum-titanium electrode, or a high silicon cast iron electrode.
